(19) United States
(12) Patent Application Publication
(10) Pub. No.: US 2004/0256482 A1
(43) Pub. Date: Dec. 23, 2004

(54) Ultrasonic atomizer and steam iron with the ultrasonic atomizer

(76) Inventor: Klaus Van Der Linden, Unterlangenstadt (DE)

Correspondence Address: LERNER AND GREENBERG, PA, P O BOX 2480, HOLLYWOOD, FL, 33022-2480, US

(21) Appl. No.: 10/461,912

(22) Filed: Jun. 13, 2003

Related U.S. Application Data
(63) Continuation of application No. PCT/EP01/13983, filed on Nov. 29, 2001.

(30) Foreign Application Priority Data
Dec. 13, 2000 (EP) 00127359.8

(51) Int. Cl. B05B 1/08

(52) U.S. Cl. 239/102.1

(57) ABSTRACT

An ultrasonic atomizer that is particularly simple to produce and in which desired vibration modes can be excited in a targeted fashion has a piezoelectric vibrator which is formed as a full-area panel and is joined to a substrate panel. The substrate panel is formed with at least one cutout in the form of a through opening. The geometric variables of the hole, such as the length, width, surface area or diameter, are selected in a specific way in order to define the working frequency of the unit with the piezoelectric vibrator and the substrate panel. An ultrasonic atomizer of this type is particularly advantageously used to generate a spray mist for an electric iron.

### CROSS-REFERENCE TO RELATED APPLICATIONS

This application is a continuation of copending International Application No. PCT/EP01/13983, filed Nov. 29, 2001, which designated the United States and which was not published in English.

### BACKGROUND OF THE INVENTION

### FIELD OF THE INVNETION

The invention relates to an ultrasonic atomizer for generating a liquid spray mist and to a specific application of the device in a steam iron.

Ultrasonic atomizers are used when high demands are imposed on the spray mist to be produced, in particular with regard to as homogeneous a distribution as possible or as accurate metering as possible. In this context, possible fields of application are, for example, their use in painting equipment, atmospheric humidifiers, medical devices—in which a medically active aerosol is to be generated in defined doses—or alternatively household appliances, such as for example irons, in which ultrasonic atomizers are used to generate a mist of water which aids in the ironing process with particular success.

U.S. Pat. No. 6,035,563 and German patent DE 197 35 214 C2 describe an iron which, inter alia, includes a piezoelectric atomization device. The piezoelectric element of the piezoelectric atomization device in this case has a number of deliberately arranged openings. Therefore, the production of a piezoelectric element of this type requires a correspondingly complex production process.

European patent application EP 1 005 917 A1 describes an inhaler with an ultrasonic atomizer. The latter comprises a first substrate and a second substrate, as well as a means for generating vibrations.

The two substrates and also the vibrator are in that case substantially three-dimensional, specially designed bodies. In particular the first substrate, which includes the outlet means for the atomized liquid, has a very complex design in order to optimally assist the main vibration mode which is induced.

A drawback of that configuration is that an ultrasonic atomizer designed in that manner is complex to produce, since in particular it is necessary to produce complicated three-dimensional substrate bodies which have to have a very specific, accurately produced geometry in order to ensure that the atomization is successful.

U.S. Pat. No. 5,716,002 and European patent application EP 0 689 879 A1 disclose an ultrasonic atomizer which is particularly suitable for medical applications in which a relatively small quantity of liquid is to be atomized. For that purpose, there is in particular a specially designed coupling body in order to ensure good wetting with the minimum possible amount of medicament liquid to be atomized.

A drawback of that prior art ultrasonic atomizer is that it is not suitable for atomizing relatively large quantities of liquid.

### SUMMARY OF THE INVENTION

It is accordingly an object of the invention to provide an ultrasonic atomizer, which overcomes the above-mentioned disadvantages of the heretofore-known devices and methods of this general type and which provides for an ultrasonic atomizer that is simple to produce, that has favorable discharge characteristics with regard to the spray mist to be produced, and that covers a wide range of applications.

With the foregoing and other objects in view there is provided, in accordance with the invention, an ultrasonic atomizer, comprising:

a substrate panel; and

a piezoelectric vibrator formed as a full-area panel joined to the substrate panel by surface-to-surface bonding;

the substrate panel having at least one cutout in the form of a hole formed therein.

In other words, the objects of the invention are achieved by an ultrasonic atomizer having a piezoelectric vibrator in which the piezoelectric vibrator is formed as a full-area panel that is joined to a substrate panel which has a through-hole formed therein.

Unlike in the prior art, the ultrasonic atomizer according to the invention is simple to produce, since its main components do not require any special production steps in which a complicated three-dimensional geometric shape is imparted to one or more components of the atomizer.

In particular, the range of uses for the ultrasonic atomizer according to the invention is not restricted to applications in which a relatively small quantity of liquid is to be atomized.

With regard to the ultrasonic atomizer according to the invention, a panel is to be understood as meaning a plate-like structure which has two planar boundary surfaces parallel to one another. Furthermore, this plate-like structure should have a small thickness compared to its length.

A panel is referred to as full-area if, on one of the boundary surfaces, two edge points which lie opposite one another with respect to the center of gravity of the panel can always be connected by a straight line with the straight lines lying entirely within the surface in question. Minor irregularities at the edge of the boundary surface in question should be disregarded.

As noted, the substrate panel advantageously has at least one cutout. The targeted geometric configuration of the cutout of the substrate panel makes it possible to excite specific vibration modes of the structure comprising piezoelectric vibrator and substrate panel joined to it.

In this way it is possible, for example, to place the working frequency of the ultrasonic atomizer specifically in a frequency range well away from the audibility limit, in order to avoid acoustic interference during operation.

Furthermore, the variation in the size and geometric configuration of the cutout in the substrate panel makes it possible to have a targeted influence on the size of the liquid droplets formed during the atomization-process. Compared to the variation in the geometry of the piezoelectric vibrator, the variation in the geometry of the cutout in the substrate panel represents a task which is easy to implement in technical terms.

The cutout advantageously extends over the geometric center of gravity of the substrate panel, i.e., given an elliptical, circular or regular-polygonal cross section of the substrate panel, over the center point. This makes it particularly easy to adapt to the desired vibration mode.

In a further advantageous configuration of the invention, the piezoelectric vibrator and/or the substrate panel are formed as at least substantially round panels.

The fact that the round shape has numerous symmetries means that the vibrations are particularly homogeneous along the surface of the piezoelectric vibrator. The same is true when a substantially round substrate panel is used. Since the substrate panel has the role of exciting or suppressing certain vibration modes, a substrate panel which is symmetrical in a large number of extents is advantageous in order to achieve this effect as homogeneously as possible. Moreover, round panels are easy to produce.

It is advantageous for both the piezoelectric vibrator and the substrate panel to be formed as round panels, the substrate panel having a central hole.

In this configuration of the invention, the symmetry properties of the components in question manifest themselves particularly successfully and complement one another. Furthermore, a central hole is easy to produce as a cutout in the substrate panel.

In a further advantageous configuration of the invention, the substrate panel consists of steel.

Steel is a material which is easy to purchase or produce. Furthermore, there is a wide range of known ways of processing steel easily and without problems.

The piezoelectric vibrator is advantageously adhesively bonded to the substrate panel; in particular, the vibrator and substrate panel are adhesively bonded to one another over a large area.

An adhesive bond is easy to produce and in the ultrasonic atomizer according to the invention offers the advantage that when the adhesive layer is distributed as homogeneously as possible the vibrations of the piezoelectric vibrator joined to the substrate panel are not adversely affected to the same extent as with a punctiform bonding.

In a further advantageous configuration of the invention, the substrate panel has at least one hole which is closed off by at least one auxiliary means.

The auxiliary means in this case has a thickness which is considerably less than that of the substrate panel.

Closing up the hole in the substrate panel by an auxiliary means offers the advantage that the heat which is produced at the piezoelectric vibrator in particular during operation without liquid can be dissipated more easily, since the heat is transferred to the auxiliary means in contact with the piezoelectric vibrator and is distributed over the surface of this auxiliary means. If the surface of the auxiliary means is as least slightly larger than the cross section of the hole, the dissipation of heat is improved, since the surface of the auxiliary means is in direct communication with the environment. During operation with liquid, the auxiliary means furthermore offers the advantage of protecting the piezoelectric vibrator from corrosion if the liquid which is to be atomized is supplied from that side of the substrate panel which is remote from the vibrator. The liquid then no longer comes into direct contact with the surface of the piezoelectric vibrator.

The auxiliary means is advantageously a plastic film and/or a coating and/or a metal foil.

The auxiliary means mentioned above make it particularly easy to close off the hole without involving high levels of outlay.

It is advantageous for the ultrasonic atomizer to be used in a steam iron in order to produce a spray mist. The ironing device according to the invention has a reservoir for storing a liquid to be atomized, an ultrasonic atomizer as outlined above disposed to generate a spray mist from the liquid, a pressing plate for ironing items exposed to the spray mist generated by the ultrasonic atomizer.

Other features which are considered as characteristic for the invention are set forth in the appended claims.

Although the invention is illustrated and described herein as embodied in an ultrasonic atomizer, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a plan view onto a piezoelectric vibrator which is joined to a substrate panel in accordance with the invention;

FIG. 2 is a side view of a section through the piezoelectric vibrator joined to a substrate panel, taken along the line II-II in FIG. 1;

FIG. 3 is a longitudinal section through an ultrasonic atomizer; and

FIG. 4 is an exploded bottom perspective view of an electric iron with an ultrasonic atomizer according to the invention.

### DESCRIPTION OF THE PREFERRED EMBODIMENTS

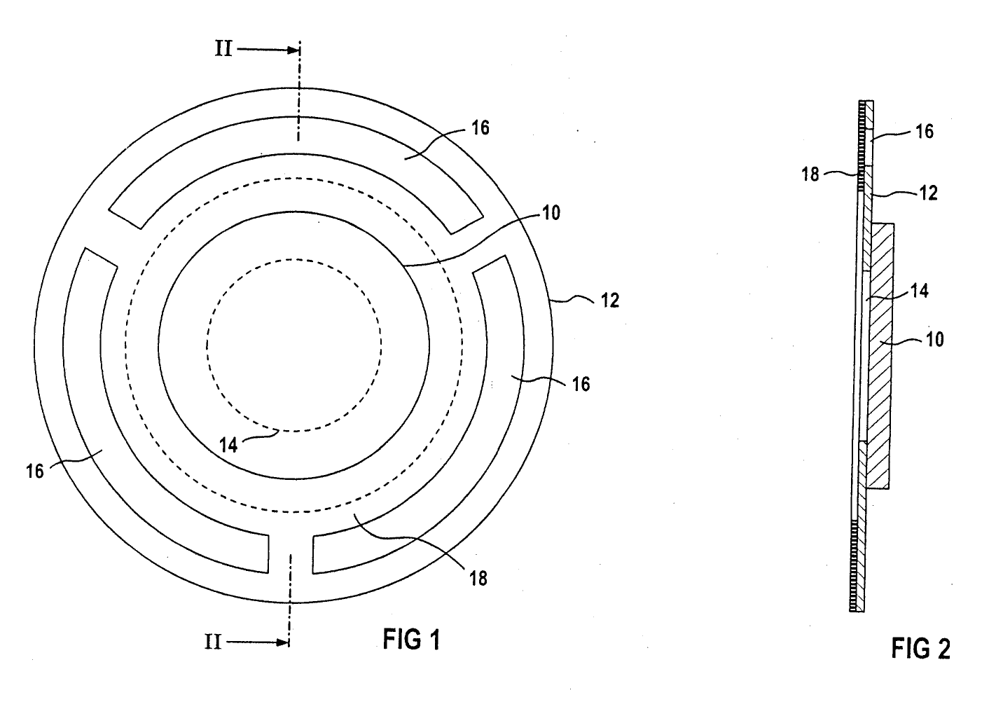

Referring now to the figures of the drawing in detail and first, particularly, to FIG. 1 thereof, there is shown shows a full-area piezoelectric vibrator 10 which is joined to a substrate panel 12. As a cutout 14, the substrate 12 has a central hole. In this embodiment, both the piezoelectric vibrator 10 and the substrate panel 12 are formed as round panels. The piezoelectric vibrator 10 and the substrate panel 12 form a sandwich configuration and they are preferably joined to one another by surface-to-surface bonding. The liquid to be atomized can be fed to this sandwich configuration in a manner which is not illustrated in more detail in FIG. 1. The substrate panel 12 is advantageously formed with through-openings 16 through which, when the ultrasonic atomizer is operating, the liquid to be atomized or has already been atomized can pass.

The geometric parameters of the cutout 14 of the substrate panel 12, such as for example the length, width, surface area, or diameter, can be deliberately configured in such a way that the unit comprising piezoelectric vibrator 10 and substrate panel 12, which is excited by way of an exciter device, which is not shown in more detail, vibrates at a desired working frequency.

FIG. 2 shows a side view of the configuration of FIG. 1, along the section line II-II. The through-openings 16 are covered by a perforated film or foil 18, which in the present exemplary embodiment is designed as a perforated annular disk. The holes in the perforated film or foil 18 preferably have a diameter of approximately 50 μm. The purpose of the holes is to ensure that it is impossible for any liquid to pass through them when the ultrasonic atomizer is not in operation, i.e. when the piezoelectric vibrator is not excited. The perforated film or foil 18 is adhesively bonded or glued, preferably a surface-to-surface bonding, to the substrate panel 12.

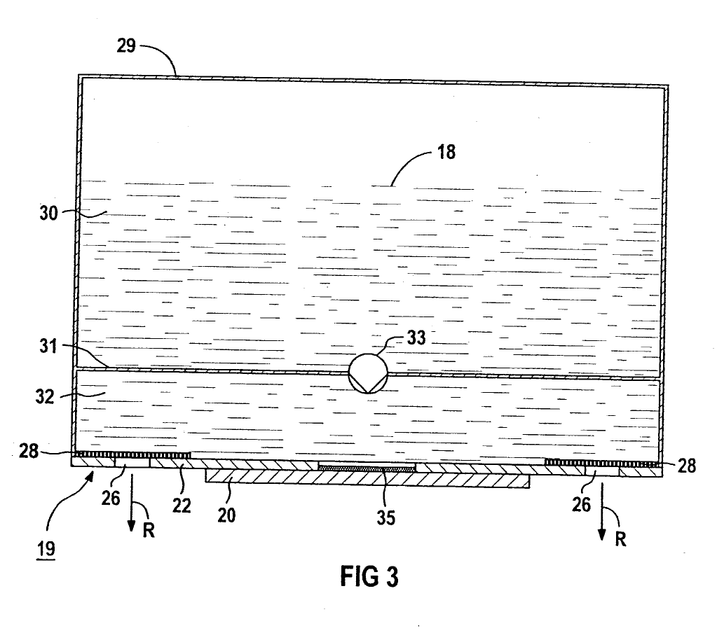

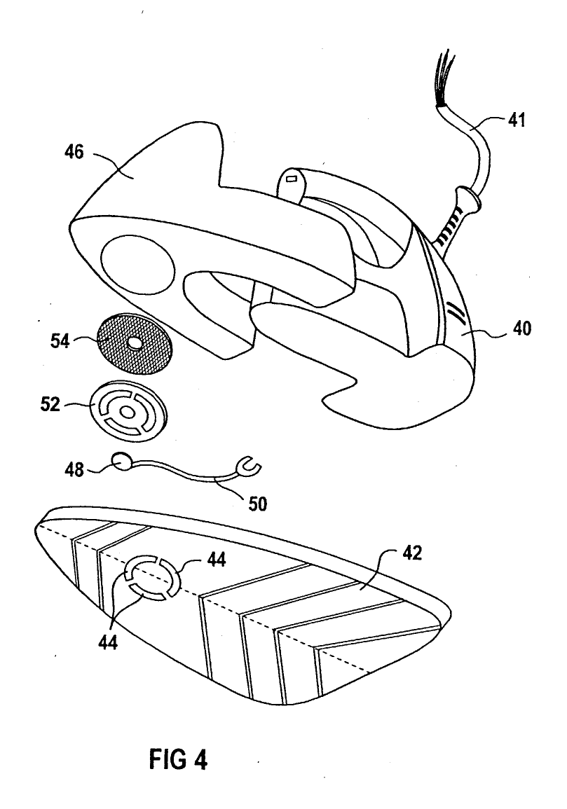

FIG. 3 shows an ultrasonic atomizer 19. It is joined to a tank housing 29 which comprises two spaces (30, 32) separated by a partition 31. When the ultrasonic atomizer 19 is operating, there is liquid 34 in both spaces. The liquid in the working space 32 is the liquid used for atomization the next time an actuating device (not shown) of the ultrasonic atomizer 19 is actuated. A particularly good atomization result is achieved if the pressure in the liquid is distributed as evenly as possible within the working space 32. To ensure a pressure distribution of this nature, liquid from the reservoir 30 can be deliberately conveyed into the working space 32 with the aid of the delivery means 33, which is preferably designed as a pump, in order to compensate for pressure fluctuations in the liquid which occur in the working space 32 while the ultrasonic atomizer 19 is operating.

The ultrasonic atomizer 19 also comprises a full-area piezoelectric vibrator 20 which is adhesively bonded to a substrate panel 22. The latter, in the present exemplary embodiment, is formed as a disk. The substrate panel 22 has a central hole which is closed off by an auxiliary means 35, for example by a coating. The thickness of the auxiliary means 35 should be small compared to the thickness of the substrate panel 22. Furthermore, the substrate panel 22 has through-openings 26 which are covered by an annular perforated film or foil 28 or a porous annular disk.

When the ultrasonic atomizer 19 is then operated by an actuating device being actuated, the piezoelectric vibrator 20 is electrically excited by an exciter device, causing the unit comprising the piezoelectric vibrator 20 and the substrate panel 22 to vibrate. This excitation atomizes the liquid into liquid droplets which are small enough to pass through the holes in the perforated film or foil 28 and to be discharged through the through-openings 26 in direction R.

The auxiliary means 35 which is used to close off the central hole in the substrate panel improves the dissipation of heat from the piezoelectric vibrator 20 in particular when there is no liquid 34 in the tank housing 29 yet the ultrasonic atomizer 19 continues to be actuated. Furthermore, closing the central hole in the substrate panel by means of the auxiliary means 35 offers the advantage that the forces which occur at the boundary between the piezoelectric vibrator and the substrate panel are reduced, and consequently the likelihood of breaking is also reduced.

FIG. 4 shows an electric iron 40 which is supplied with electrical energy via a cord 41. The iron 40 comprises an ultrasonic atomizer, which is fed with liquid from a tank housing 46, and a perforated film or foil 54, a substrate panel 52 and a piezoelectric vibrator 48. The piezoelectric vibrator 48 is driven and made to vibrate by an exciter device via a connection line 50. The ultrasonic atomizer or at least its exciter device is actuated by means of an actuating device, causing the piezoelectric vibrator 48 to vibrate. These vibrations cause water droplets which are small enough to pass through the holes in the perforated film or foil 54 to form in the tank housing 46 in the vicinity of the piezoelectric vibrator 48 or the substrate panel 52. The water droplets can then pass through the through-openings in the substrate panel 52 and are discharged through apertures 44 in the pressing plate or iron sole plate 42 in the direction of the item which is to be ironed.

I claim:

1. An ultrasonic atomizer, comprising:
a substrate panel; and
a piezoelectric vibrator formed as a full-area panel joined to said substrate panel by surface-to-surface bonding;
said substrate panel having at least one cutout in the form of a hole formed therein.

2. The ultrasonic atomizer according to claim 1, wherein at least one of said piezoelectric vibrator and said substrate panel is a substantially round panel.

3. The ultrasonic atomizer according to claim 1, wherein said piezoelectric vibrator is a round panel and said substrate panel is a round panel formed with a central hole.

4. The ultrasonic atomizer according to claim 1, wherein said substrate panel consists of steel.

5. The ultrasonic atomizer according to claim 1, wherein said piezoelectric oscillator is adhesively bonded to said substrate panel.

6. The ultrasonic atomizer according to claim 1, wherein said hole in said substrate panel is closed off by at least one auxiliary means.

7. The ultrasonic atomizer according to claim 6, wherein said auxiliary means is a structure selected from the group consisting of a plastic film, a coating, and a metal foil.

8. In an ironing process, a method of generating a spray mist for aiding in the ironing process, the method which comprises: providing an iron with the ultrasonic atomizer according to claim 1, and generating the spray mist with the ultrasonic atomizer during the ironing process.

9. An ironing device, comprising:
a tank housing for storing a liquid;
an ultrasonic atomizer according to claim 1 disposed to generate a spray mist from the liquid stored in said tank housing; and
a pressing plate for ironing items exposed to the spray mist generated by said ultrasonic atomizer.

10. The ironing device according to claim 9, wherein said ultrasonic atomizer is disposed between said tank housing and said pressing plate, and said pressing plate is formed with apertures through which the spray mist generated by said ultrasonic atomizer is discharged.
